(19) United States
(12) Patent Application Publication
(10) Pub. No.: US 2010/0234153 A1
(43) Pub. Date: Sep. 16, 2010

(54) TRANSMISSION NEUTRALIZING STRUCTURE FOR PEDAL-POWERED VEHICLE

(76) Inventor: I-Shyong Lu, Taichung City (TW)

Correspondence Address: CHARLES E. BAXLEY, ESQUIRE, 90 JOHN STREET, SUITE 309, NEW YORK, NY, 10038, US

(21) Appl. No.: 12/734,593

(22) PCT Filed: Mar. 24, 2009
(86) PCT No.: PCT/CN2009/000311

§ 371 Date: May 11, 2010

(30) Foreign Application Priority Data
Mar. 27, 2008 (CN) 200820005646.9

(51) Int. Cl. B62M 9/12

(52) U.S. Cl. 474/78

(57) ABSTRACT

A transmission neutralizing structure for a pedal-powered vehicle is disclosed. The transmission neutralizing structure is provided on one of sprocket sets of the vehicle, and includes a free gear and a bearing by which a center of the free gear is coupled with a rotatory assembly so that the rotatory assembly and the free gear are rotationally disconnected in both directions. The pedal-powered vehicle has a chain shiftable between the sprocket set and the free gear under control of a derailleur gear unit. When the derailleur gear unit is set in a neutral gear position, the chain is engaged with the free gear. The free gear further has a safety device, which kinetically couples the free gear with the sprocket set.

### BACKGROUND OF THE INVENTION

1. Technical Field

The present invention relates to a transmission neutralizing structure for a pedal-powered vehicle that has a gear system or a freewheel system, wherein the pedal-powered vehicles include, but are not limited to, bicycles, tricycles, tandem bicycles, folding bicycles, etc. The transmission neutralizing structure releases the gear system or freewheel system of the pedal-powered vehicle from engagement and thus puts the vehicle in neutral so that when the vehicle are drawn forward or backward, cranks and pedals of the vehicle stay still but not rotate with the movement of its wheels.

2. Description of Related Art

When a cyclist walks with his/her bicycle, such as one described in U.S. Pat. No. 4,838,569, a problem likely to bother him/her is the backward-turning cranks and pedals that tend to accidentally hook or hit external objects, for example, the cyclist's leg adjacent to the turning pedal.

A folding bicycle, such as that disclosed in U.S. Pat. No. 7,510,202, when dragged, also has the same problem that the backward-turning cranks and pedals are seized by the folded bicycle frame, causing the folding bicycle unwalkable or even damaged.

Besides, the inventor of the present invention has previously proposed a scheme that combines a folding bicycle with a basket to allow the folding bicycle to act as a trolley when not ridden. However, the backward turning cranks and pedals substantially hinder existing pedal-powered vehicles from safely moving in narrow space, such as in an elevator, and pose underlying risks of injuring people and object around the pedal-powered vehicles or even damaging the pedal-powered vehicles themselves.

### SUMMARY OF THE INVENTION

The present invention thus proposes a compact transmission neutralizing structure to solve the foregoing problems happening to the existing pedal-powered vehicles whose cranks and pedals turn backward when dragged backward.

The transmission neutralizing structure of the present invention is provided at one of sprocket sets of a pedal-powered vehicle. The transmission neutralizing structure comprises a free gear and a bearing. The free gear has a center mounted around a rotatory assembly of the sprocket sets by means of the bearing so that the rotatory assembly and the free gear are rotationally disconnected in both directions. A chain of the pedal-powered vehicle is controlled by a derailleur gear unit to be shifted between the sprocket set and the free gear. When the derailleur gear unit is put in a neutral gear position, the chain is engaged with the free gear. The free gear further has a safety device, which kinetically couples the free gear and the sprocket set.

The transmission neutralizing structure of the present invention thereby has an effect that when a user drags the pedal-powered vehicle backward, both cranks and pedals of the vehicle are not driven to turn, so that external objects and the user's body can be saved from damages that may be otherwise caused by backward-turning cranks and pedals, and that ensures a safe and convenient movement of the pedal-powered vehicle.

The transmission neutralizing structure of the present invention thereby has another effect that when the pedal-powered vehicle, being a folding bicycle with a basket, is folded and used as a cart, since both cranks and pedals are not driven, the cart can be freely moved forward or backward.

The transmission neutralizing structure of the present invention thereby has another effect that prior to riding the pedal-powered vehicle, a user may set the safety device to kinetically couple the free gear and the sprocket set, so that in the user's later riding, pedals and cranks of the vehicle can drive the free gear to allow the pedal-powered vehicle to operate and advance normally.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a pedal-powered vehicle with a transmission neutralizing structure of the present invention;

FIG. 2 is an exploded view of a rear sprocket set on a rear wheel with the transmission neutralizing structure of the present invention;

FIG. 3 is a sectional view of the transmission neutralizing structure on the rear sprocket set;

FIG. 4 is a schematic drawing depicting the rear wheel having the transmission neutralizing structure of the present invention;

FIG. 5 is a schematic drawing showing the transmission neutralizing structure of the present invention equipped with a safety device;

FIG. 6 is another perspective view of the pedal-powered vehicle wherein the vehicle is folded and lowed to freely move forward and backward in virtue of the transmission neutralizing structure of the present invention;

FIG. 7 is a lateral view of the pedal-powered vehicle of FIG. 6;

FIG. 8 is an exploded view of a front sprocket set on a bicycle frame with the transmission neutralizing structure of the present invention;

FIG. 9 is a schematic drawing showing a gear switch of the present invention provided with a movable retainer;

FIG. 10 provides an alternative embodiment of the transmission neutralizing structure of the present invention;

FIG. 11 is an exploded view of the transmission neutralizing structure of FIG. 10 applied to a front sprocket set;

FIG. 12 is an assembled perspective view of the transmission neutralizing structure of FIG. 11;

FIG. 13 is a front view according to FIG. 12 showing the free gear and the rotatory assembly kinetically coupled;

FIG. 14 is another front view according to FIG. 12 showing the free gear and rotatory assembly rotationally disconnected;

FIG. 15 is a partial sectional view taken along Line 15-15 of FIG. 13;

FIG. 16 is a partial sectional view taken along Line 16-16 of FIG. 13;

FIG. 17 is a partial sectional view taken along Line 17-17 of FIG. 13;

FIG. 18 is a schematic drawing according to FIG. 17 showing an operating element departed from a first annular turntable; and

FIG. 19 is a schematic drawing showing the transmission neutralizing structure of the present invention applied to the front sprocket set.

### DETAILED DESCRIPTION OF THE INVENTION

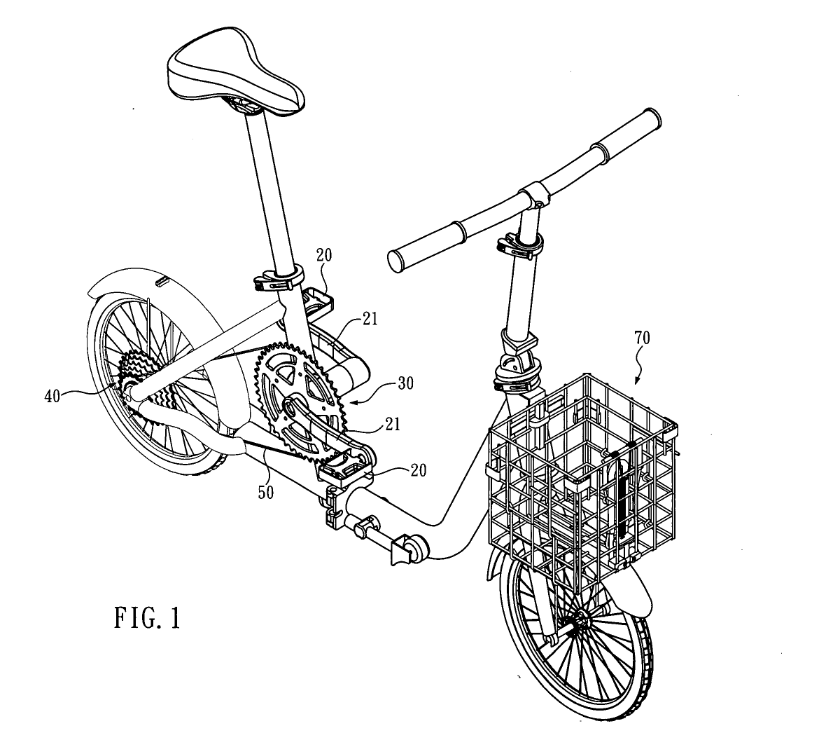

As shown in to FIG. 1, a transmission neutralizing structure 10 of the present invention is applied to a pedal-powered vehicle. In the pedal-powered vehicle, components associated with transmission neutralizing structure 10 include pedals 20, cranks 21, a front sprocket set 30, a rear sprocket set 40, and a chain 50.

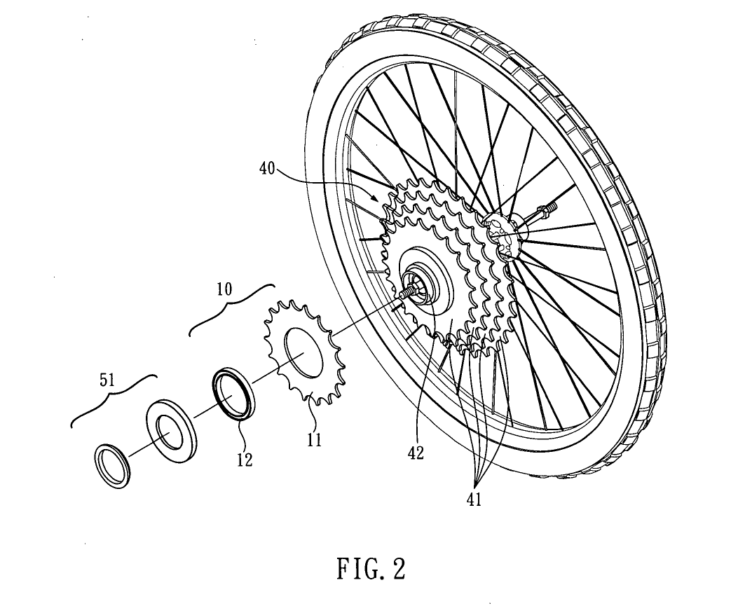

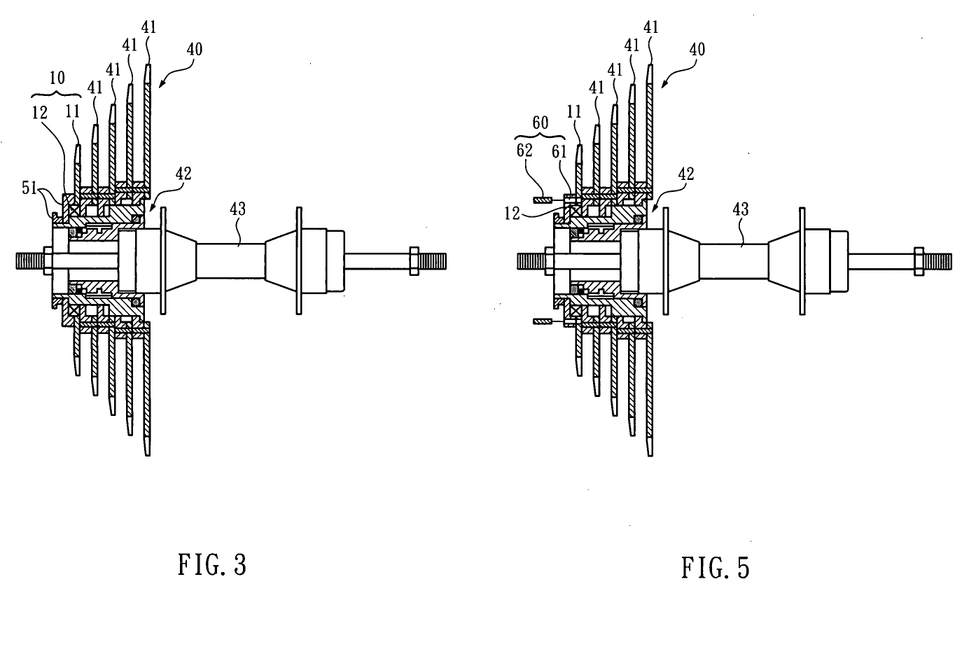

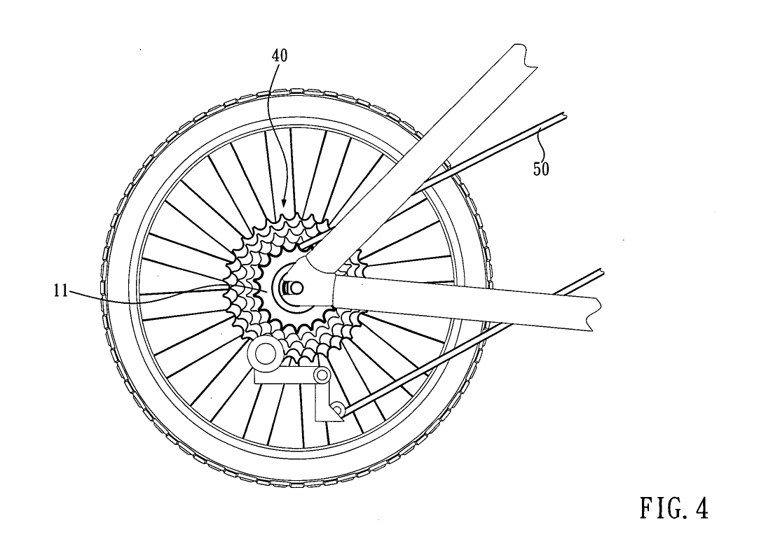

Referring to FIGS. 2, 3 and 4, the transmission neutralizing structure 10 is herein applied to the rear sprocket set 40. The rear sprocket set 40 is composed of a plurality of transmission gears 41 whose diameters and tooth numbers are subject to gradient change. The transmission gears 41 are coaxially mounted around a rotatory assembly 42; which is mounted around an end of a rear hub 43. The transmission gears 41, the rotatory assembly 42 and the rear hub 43 are kinetically coupled mutually.

The transmission neutralizing structure 10 of the present invention is provided in the rear sprocket set 40, and includes a free gear 11 and a bearing 12. The free gear 11 is mounted around the rotatory assembly 42 with the bearing 12 settled therebetween, so that the bearing 12 makes the rotatory assembly 42 and the free gear 11 rotationally disconnected in both directions. The transmission neutralizing structure 10 may be additionally provided to the existing rear sprocket set 40, or may be embodied by modifying any of the transmission gears 41 of the rear sprocket set 40. In the present embodiment of the present invention, the gear smallest in diameter is implemented as the free gear 11. A retaining assembly indicated by the numeral 51 in the drawings is fixed to the rotatory assembly 42 for axially retaining and positioning the free gear 11 and the other transmission gears 41.

The chain 50 is controlled by a derailleur gear unit of the pedal-powered vehicle to be shifted among the transmission gears 41 and the free gear 11. It is to be noted that when a gear switch 80 of the derailleur gear unit is put in a neutral gear position, the chain 50 is engaged with the free gear 11. At this time, when the pedal-powered vehicle is dragged backward, the cranks 21 and the pedals 20, instead of turning backward, stay non-driven. The underlying principle is that when the pedal-powered vehicle is dragged backward, the rotating rear wheel drives the rear hub 43 to rotate the rotatory assembly 42 and the transmission gears 41. Thereupon, since the free gear 11 and the rotatory assembly 42 are rotationally disconnected in both directions, the free gear 11 is not driven by the rotatory assembly 42 and stays still. Consequently, the chain 50, the front sprocket set 30, the cranks 21 and the pedals 20 are all not driven. Thus, as long as a user, prior to his/her drag of the pedal-powered vehicle, puts the gear switch 80 of the derailleur gear unit in the neutral gear position, the cranks 21 and pedals 20 do not rotate with the backward moving vehicle, so as to ensure the safety and convenience of dragging the pedal-powered vehicle.

On the other hand, for preventing the pedal-powered vehicle in normal riding operation from being unintentionally switched to neutral gear, the present invention also provides solutions to that.

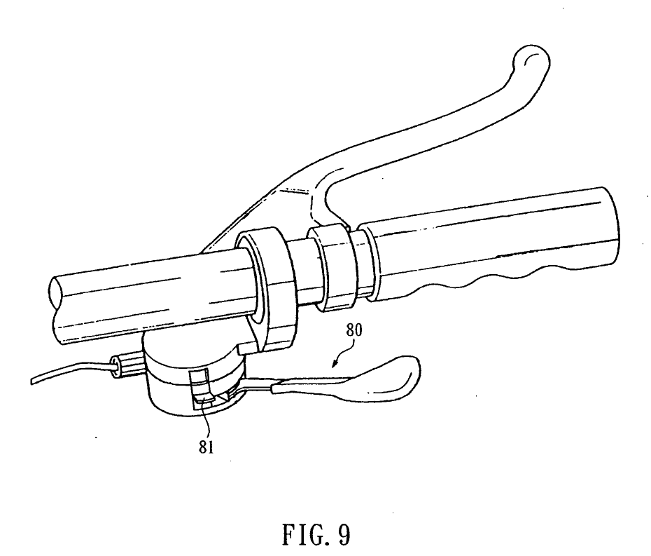

The first solution, as shown in FIG. 9, is to provide a movable retainer 81 to the gear switch 80. The movable retainer 81 separates normal gear positions from the neutral gear position of the gear switch 80, and the movable retainer 81 is configured to be operatble to the user. The user has to first operate the movable retainer 81, which acts as a safety device, and then the gear switch 80 is allowed to be put in the neutral gear position so as to prevent the pedal-powered vehicle from being unintentionally put in neutral gear.

The other solution relies on a safety device 60 provided on the free gear 11. Referring to FIG. 5, the safety device 60 is composed of a through hole 61 passing through the retaining assembly 51 and the free gear 11 and a positioning pin 62 received in the through hole 61. By the safety device 60, a kinetic connection among the rotatory assembly 42, the retaining assembly 51 and the free gear 11, so that when the chain 50 is engaged with-the free gear 11, the moving chain 50 drives the free gear 11 that is kinetically coupled with the retaining assembly 51 and the rotatory assembly 42, and in turn rotates the rear hub 43 and the rear wheel. Thus, when the positioning pin 62 is set in the through hole 61 prior to the use's riding of the pedal-powered vehicle, even if the pedal-powered vehicle is unintentionally put in neutral gear during the riding, its operation remains normal.

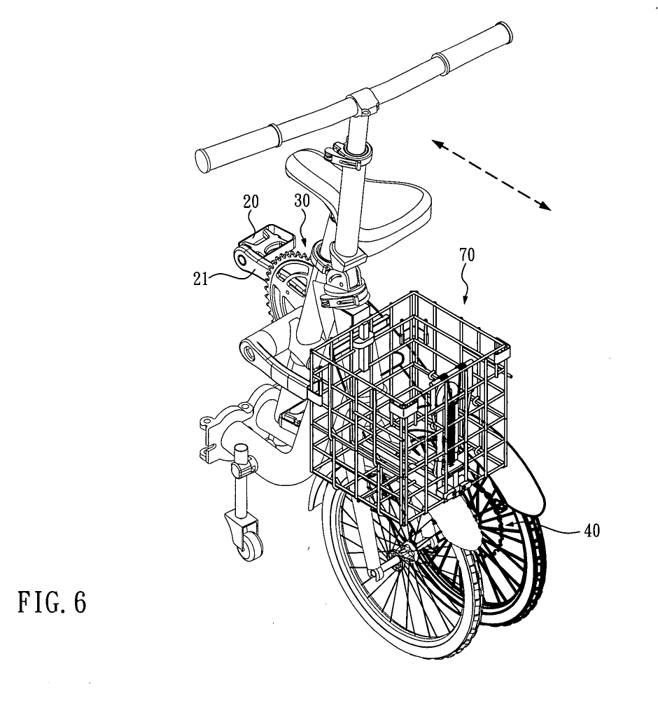

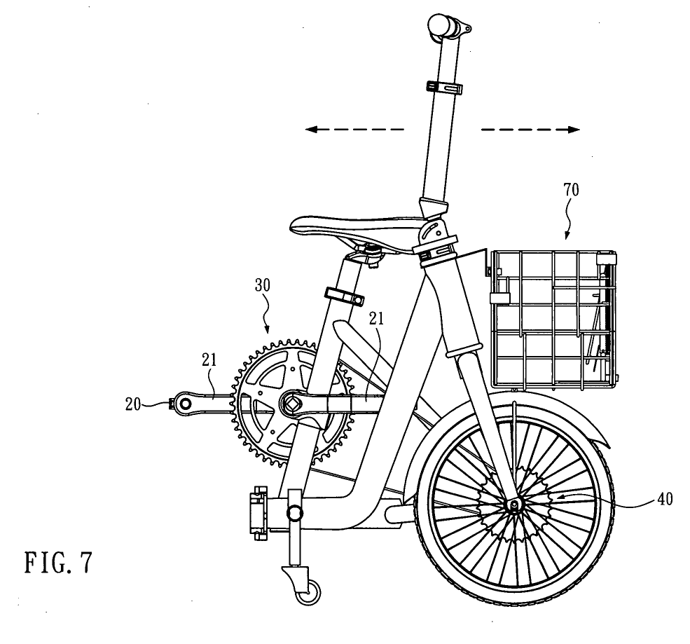

Referring to FIGS. 6 and 7, the folded pedal-powered vehicle therein is equipped with a basket 70. In virtue of the transmission neutralizing structure 10 of the present invention, when used as a cart, the pedal-powered vehicle is allowed to be drawn forward or backward freely without being hindered by the rotation of the pedals 20 and cranks 21 that otherwise happens when the transmission neutralizing structure 10 is absent, thereby being a manageable cart.

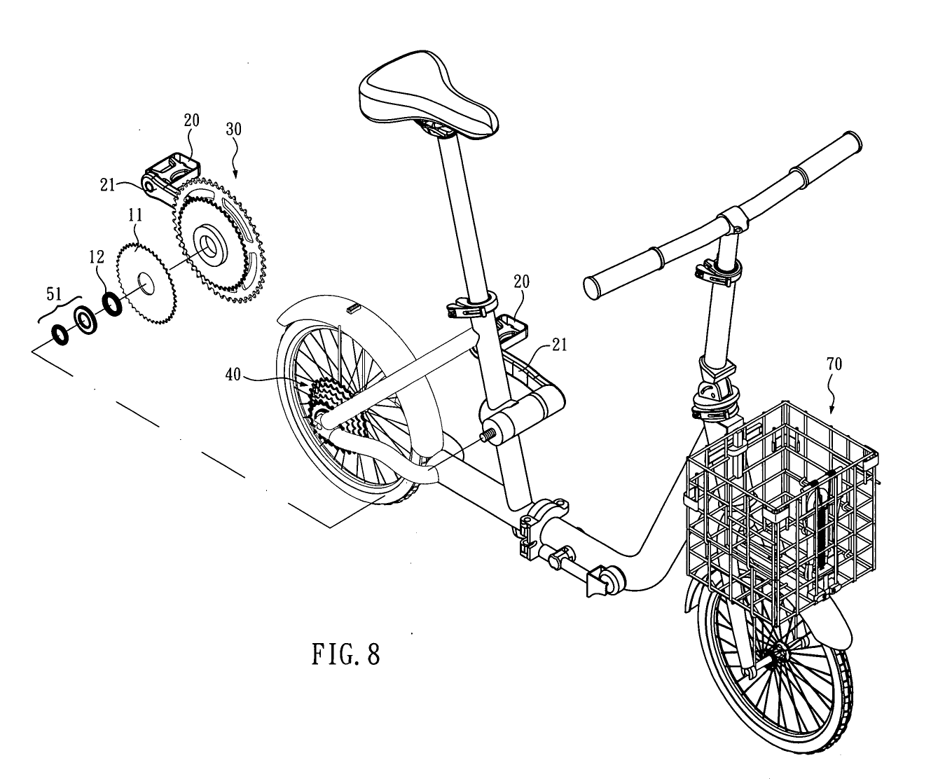

As shown in FIG. 8, the transmission neutralizing structure 10 of the present invention may be alternatively applied to the front sprocket set 30.

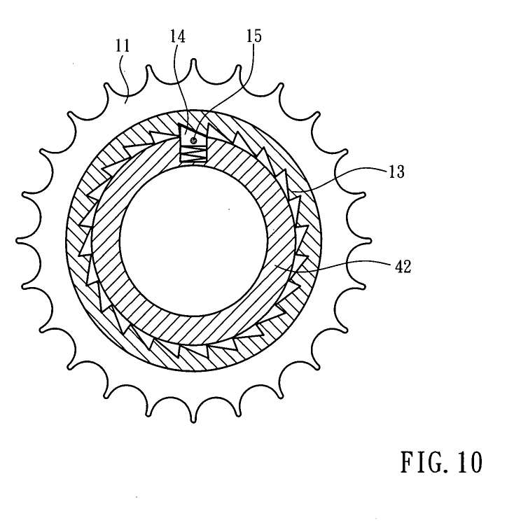

Referring to FIG. 10, in a second embodiment of the transmission neutralizing structure of the present invention, a one-way pawl structure is provided between the free gear 11 and the rotatory assembly 42. More particularly, the free gear 11 has one-way pawls 13 at its inner periphery, while the rotatory assembly 42 has a pawl stopper 14 propped outward by a spring, so that when the pawl stopper 14 gets engaged with one of the one-way pawls 13, the free gear 11 and the rotatory assembly 42 get kinetically coupled, allowing the free gear 11 to rotate in one direction for transmission. The pawl stopper 14 may be pushed by a switch 15 to thereby be hidden in the rotatory assembly 42, so as to make the free gear 11 and the rotatory assembly 42 become rotationally disconnected in both directions.

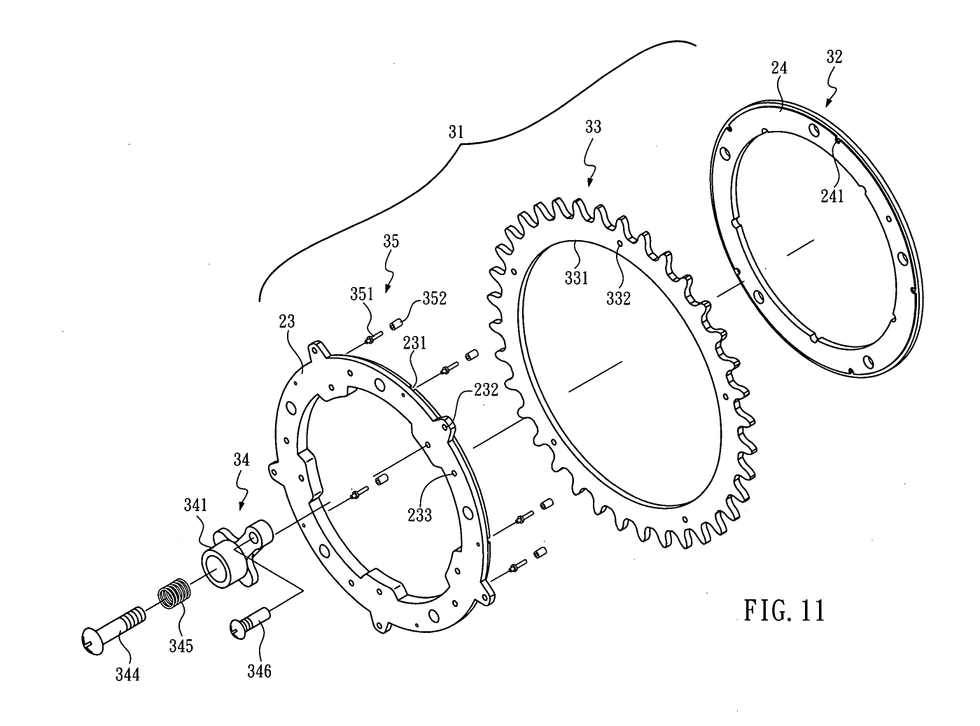

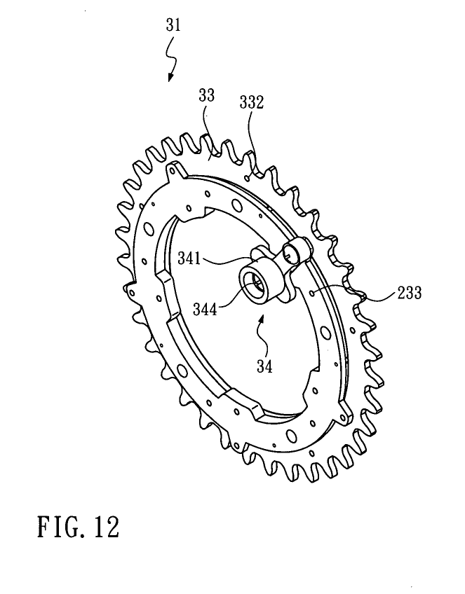

Referring to FIGS. 11 through 14, a transmission neutralizing structure 31 applied to the front sprocket set 30 includes a rotatory assembly 32, a free gear 33 and at least one clutch assembly 34. The rotatory assembly 32 is fixed to and rotates with the front sprocket set 30. The free gear 33 has a center mounted around the rotatory assembly 32 with a plurality of rolling assemblies 35 deposited therebetween so that the free gear 33 and the rotatory assembly 42 are rotationally disconnected in both directions. The clutch assembly 34 is settled on the rotatory assembly 32 to kinetically couple the rotatory assembly 32 to the free gear 33, or to make the free gear 33 rotationally disconnected with the rotatory assembly 32.

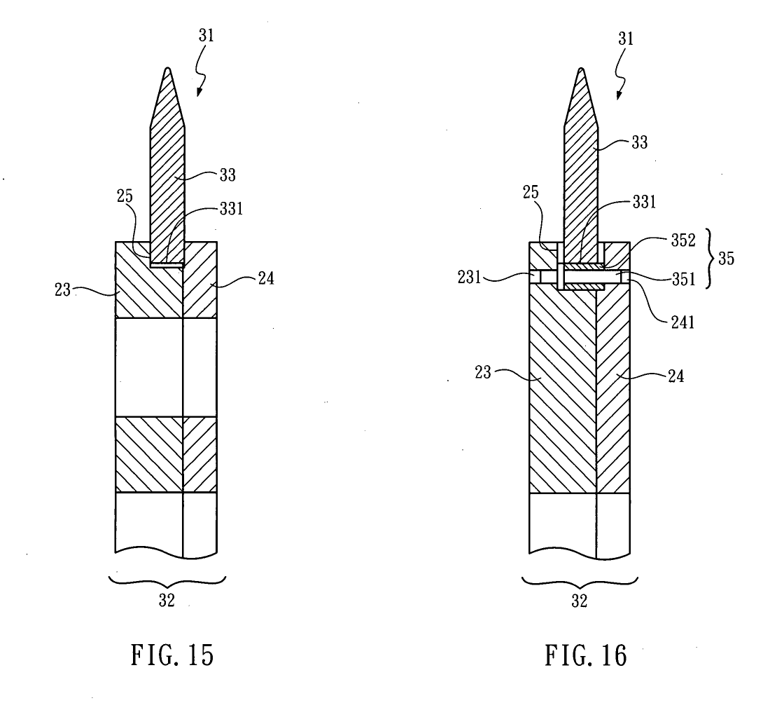

The rotatory assembly 32 includes a first annular turntable 23 and a second annular turntable 24. The first annular turntable 23 and the second annular turntable 24 are face-to-face coupled and fixed to the front sprocket set 30. The coupled first annular turntable 23 and second annular turntable 24 jointly define a positioning groove 25 peripherally (as shown in FIG. 15) for receiving an inner periphery 331 of the free gear 33.

As shown in FIG. 16, the plural rolling assemblies 35 is settled in aligned trough holes 231, 241 formed on the first annular turntable 23 and the second annular turntable 24, and is contacted by the inner periphery 331 of the free gear 33 in the positioning groove 25. Each of the rolling assemblies 35 comprises a fixer 351 and a roller 352 rotatably mounted around the fixer 351. The inner periphery 331 of the free gear 33 contacts surfaces of the rollers 352 so that the rollers 352 helps to minimize friction that retards the rotation of the free gear 33.

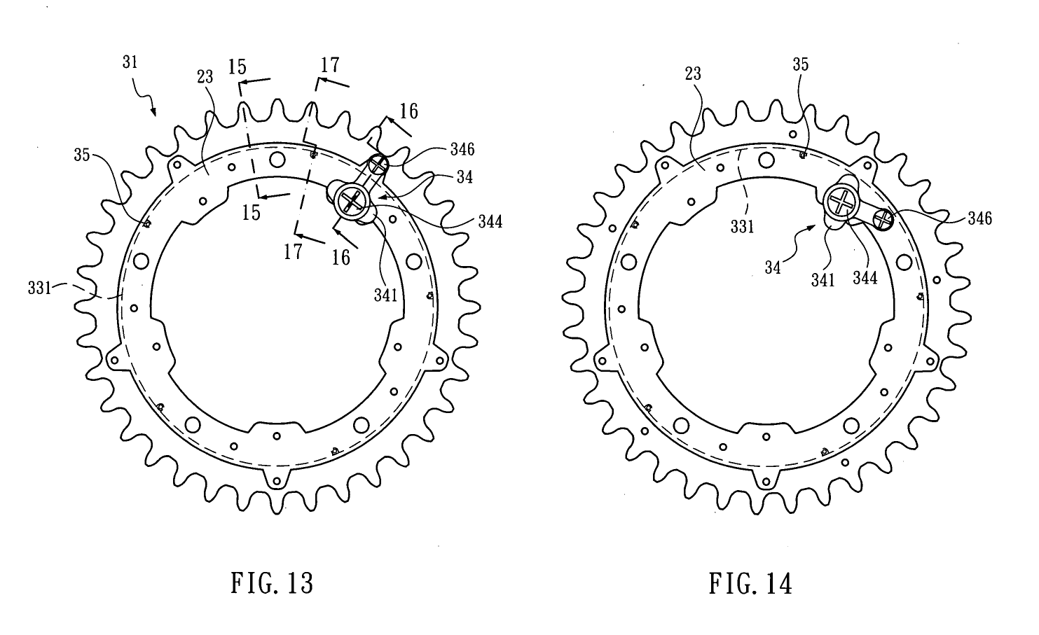

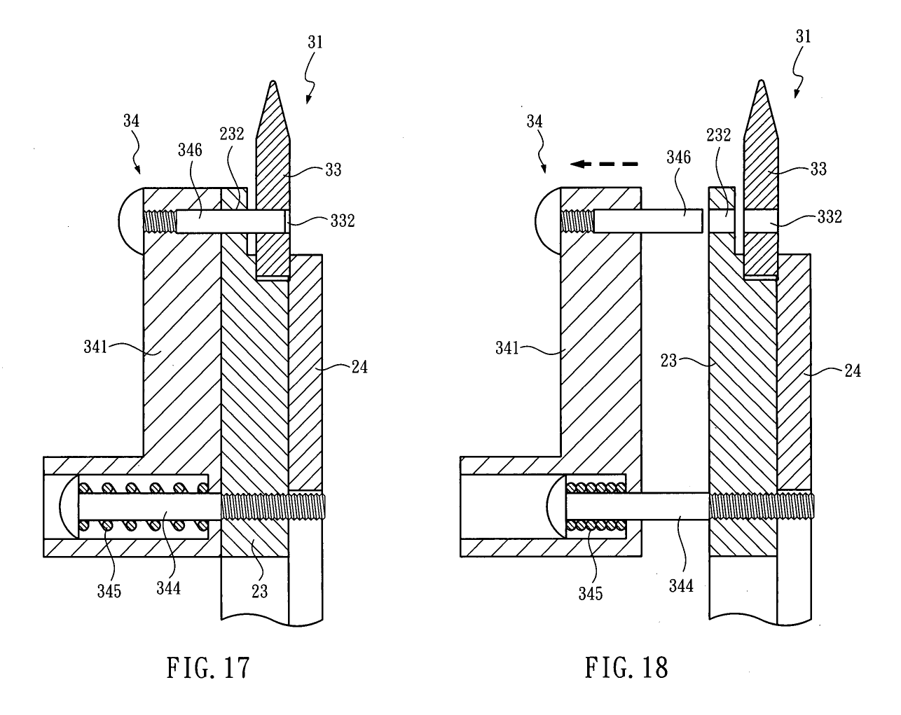

Referring to FIGS. 13, 14, 17 and 18, the clutch assembly 34 comprises an operating element 341, a rotational shaft 344 and a connecting shaft 346. The operating element 341 is positioned with respect to the first annular turntable 23 by means of the rotational shaft 344, and is allowed to rotate against the rotational shaft 344. The connecting shaft 346 passes through the operating element 341, and goes through a connecting hole 232 formed on the first annular turntable 23 and a fixing hole 332 formed on the free gear 33 successively. Thereby, the free gear 33 and the rotatory assembly 32 are kinetically coupled. In other words, the rotatory assembly 32 is enabled to drive the free gear 33.

A spring 345 is mounted around the rotational shaft 344 and located between a head of the rotational shaft 344 and the operating element 341. The spring 345 allows the operating element 341 to normally abut against the first annular turntable 23. By applying a force to compress the spring 345, the operating element 341 departs from the first annular turntable 23, and the connecting shaft 346 departs from the connecting hole 232 of the first annular turntable 23 and the fixing hole of the free gear 33, thus dismissing the kinetic connection between the free gear 33 and the rotatory assembly 32, and rotationally disconnecting the free gear 33 from the rotatory assembly 32.

The first annular turntable 23 is further formed with a receiving hole 233 near the connecting hole 232. The operating element 341 is rotated against the rotational shaft 344, so that when the connecting shaft 346 departs from the connecting hole 232 and the fixing hole 332, the receiving hole 233 receives the connecting shaft 346, making the operating element 341 still positioned with respect to the first annular turntable 23 but not rotating freely to hinder other components.

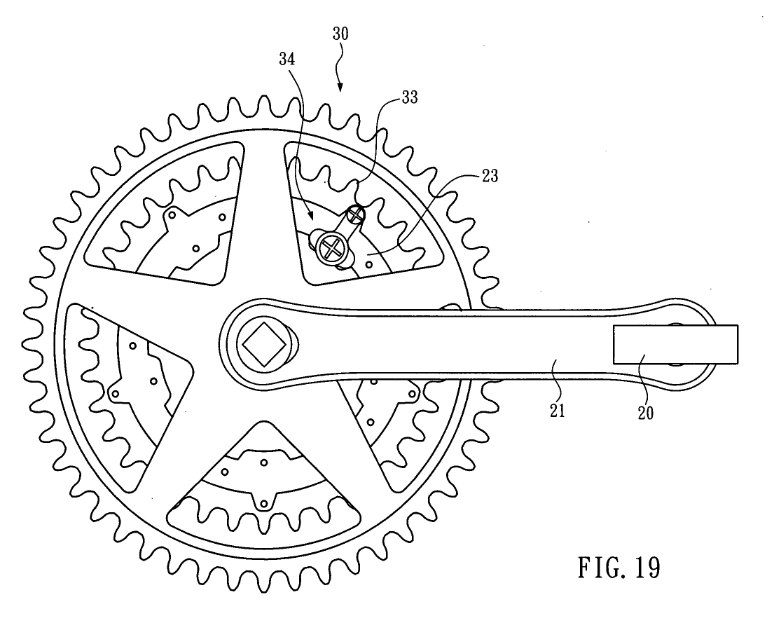

FIG. 19 shows the transmission neutralizing structure of the present invention applied to the front sprocket set. The gear switch 80 allows the chain 50 to be shifted between the free gear 33 and the front sprocket set 30. When the chain 50 is engaged with the free gear 33, and the connecting shaft 346 of the operating element 341 is departed from the connecting hole 232 of the first annular turntable 23 and the fixing hole 332 of the free gear 33, the free gear 33 and the rotatory assembly 32 are rotationally disconnected in both directions. At this time, in the vehicle dragged backward, the rotating rear wheel rotates the rear hub 43 and the chain 50 thereby drives the free gear 33, and since the free gear 33 is rotationally disconnected with the rotatory assembly 32, the rotatory assembly 32 does not drive the front sprocket set 30, so that the cranks 21 coupled with the front sprocket set 30 are free from turning backward.

On the contrary, when the connecting shaft 346 of the operating element 341 is received in the connecting hole 232 of the first annular turntable 23 and the fixing hole 332 of the free gear 33, the free gear 33 and the rotatory assembly 32 are kinetically coupled with each other. At this time, rotating the cranks 21 makes the front sprocket set 30 driving the rotatory assembly 32 and the free gear 33 to rotate, thereby making the pedal-powered vehicle advance.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A transmission neutralizing structure for a pedal-powered vehicle provided at one of sprocket sets of the pedal-powered vehicle, the transmission neutralizing structure comprising:
at least one free gear such mounted around a rotatory assembly of the sprocket set that the rotatory assembly is rotationally disconnected with the free gear in both directions.

2. The transmission neutralizing structure of claim 1, wherein the sprocket set of the pedal-powered vehicle at which the transmission neutralizing structure is provided is a rear sprocket set or a front sprocket set of the pedal-powered vehicle.

3. The transmission neutralizing structure of claim 1, wherein the transmission neutralizing structure further comprises a bearing by which a center of the free gear is coupled with the rotatory assembly so that the rotatory assembly and the free gear are rotationally disconnected in both directions, and a safety device is provided on the free gear so that the free gear and the rotatory assembly are kinetically coupled.

4. The transmission neutralizing structure of claim 1, wherein one-way pawls are provided at an inner periphery of the free gear, and a resiliently movable pawl stopper is provided at the rotatory assembly, so that when the pawl stopper gets engaged with one of the one-way pawls, the free gear and the rotatory assembly get kinetically coupled, and when the pawl stopper is disengaged from all of the one-way pawls, the free gear and the rotatory assembly become rotationally disconnected in both directions.

5. The transmission neutralizing structure of claim 1, wherein the rotatory assembly includes a first annular turntable and a second annular turntable that are face-to-face coupled and fixed to the front sprocket set so that the coupled first annular turntable and second annular turntable jointly define a positioning groove peripherally for receiving an inner periphery of the free gear.

6. The transmission neutralizing structure of claim 5, further comprising a plurality of rolling assemblies, settled in aligned trough holes formed on the first annular turntable and the second annular turntable, and contacted by the inner periphery of the free gear in the-positioning groove, each of the rolling assemblies comprising a fixer and a roller rotatably mounted around the fixer, and the inner periphery of the free gear contacting surfaces of the rollers.

7. The transmission neutralizing structure of claim 5, further comprising at least one clutch assembly that has an operating element rotationally positioned and axially movable with respect to the first annular turntable, the operating element having a connecting shaft that axially moves with respect to the fixing hole of the free gear according to relative positions between the operating element and the first annular turntable.

8. The transmission neutralizing structure of claim 7, wherein the operating element is positioned with respect to the first annular turntable by means of a rotational shaft, and a spring is mounted around the rotational shaft so as to allow the operating element to normally abut against the first annular turntable, the clutch assembly further comprising a receiving hole formed on the first annular turntable for receiving the connecting shaft that is departed from the fixing hole of the free gear.

9. The transmission neutralizing structure of claim 1, wherein the pedal-powered vehicle has a derailleur gear unit and when a gear switch of the derailleur gear unit is put into a neutral gear position, a chain of the sprocket set is engaged with the free gear.

10. The transmission neutralizing structure of claim 9, wherein a movable retainer is provided at the neutral gear position of the gear switch of the derailleur gear unit and the movable retainer is switchable.
